(19) United States
(12) Patent Application Publication
(10) Pub. No.: US 2026/0031732 A1
(43) Pub. Date: Jan. 29, 2026

(54) DC/DC Converter

(71) Applicant: HELLA GMBH & CO. KGAA, Lippstadt (DE)

(72) Inventors: Tobias Herrmann, Paderborn (DE); Jonas Issing, Lippstadt (DE); Mario Schroeder, Soest (DE)

(21) Appl. No.: 19/274,954

(22) Filed: Jul. 21, 2025

(30) Foreign Application Priority Data
Jul. 24, 2024 (DE) 102024120975.5

(51) Int. Cl. H02M 3/335

(52) U.S. Cl. CPC H02M 3/33515

(57) ABSTRACT

A DC/DC converter is provided. The DC/DC converter includes a control device for controlling LV semiconductor switches and HV semiconductor switches by means of pulse-width modulated control signals. The control device is configured to detect the LV DC voltage and the HV DC voltage based on the LV DC voltage, the HV DC voltage, and a transformation ratio of a transformer, to determine a theoretical pulse-width modulation duty cycle and to generate a pulse-width modulated control signal as a function of the theoretical pulse-width modulation duty cycle.

### CROSS-REFERENCE TO RELATED APPLICATIONS

The present application claims the benefit of German Patent Application No. 10-2024-120-975.5, filed Jul. 24, 2024, the disclosure of which is incorporated by reference.

### FIELD OF THE INVENTION

The present invention relates to a DC/DC converter, including: low-voltage connectors, to which a low-voltage DC voltage is applied during operation; high-voltage connectors, to which a high-voltage DC voltage is applied during operation; a transformer with a low-voltage winding and a high-voltage winding; a low-voltage semiconductor bridge circuit with low-voltage semiconductor switches, which is connected to the low-voltage winding of the transformer and to the low-voltage connectors; a high-voltage semiconductor bridge circuit with high-voltage semiconductor switches, which is connected to the high-voltage winding of the transformer and to the high-voltage connectors; and a control device for controlling the low-voltage semiconductor switches and the high-voltage semiconductor switches by means of pulse-width modulated control signals. Hereinafter, the term “low-voltage” is abbreviated to “LV” and the term “high-voltage” is abbreviated to “HV”.

### BACKGROUND OF THE INVENTION

DC/DC converters of the type mentioned above are also referred to as “dual active bridge converters” and are known from the prior art. Such DC/DC converters are used, for example, in electrically powered motor vehicles, hereinafter referred to as “electric motor vehicles”, wherein a low-voltage on-board electrical system of the electric motor vehicle is connected to the low-voltage connectors and a high-voltage on-board electrical system of the electric motor vehicle is connected to the high-voltage connectors. The LV on-board electrical system is typically designed for a nominal voltage of 12 V, 24 V and/or 48 V, and the HV on-board electrical system is typically designed for a nominal voltage of 400 V and/or 800 V. In the automotive sector, the term “low-voltage” is typically used to describe electrical systems that operate with AC voltages in the range up to and including 30 V or with DC voltages in the range up to and including 60 V, and the term “high-voltage” is used to describe electrical systems that operate with AC voltages in the range between 30 V and 1000 V or with DC voltages in the range between 60 V and 1500 V.

When charging the so-called traction battery of electric vehicles, the HV DC voltage applied to the HV connectors of the DC/DC converter can vary significantly depending on the type of charging system used, which is why DC/DC converters for electric motor vehicles typically have to be designed for HV DC voltages in the range from approx. 200 V to approx. 900 V. However, single-stage DC/DC converters known from the prior art typically have relatively high conversion losses, especially at relatively low HV DC voltages, so that they typically allow only relatively inefficient power transmission at relatively low HV DC voltages. For this reason, DC/DC converters for electric motor vehicles are often designed with multiple stages, which makes them complex and therefore costly and space-consuming.

### SUMMARY OF THE INVENTION

Against this background, the object of the present invention is to provide a DC/DC converter that is relatively simple in design and still enables efficient power transmission even at relatively low HV voltages. According to the invention, this task is solved by a DC/DC converter with the features of the current embodiments.

The DC/DC converter according to the invention comprises LV connectors, to which an LV DC voltage is applied during operation, and HV connectors, to which an HV DC voltage is applied during operation. Preferably, the DC/DC converter is designed for use in an electric motor vehicle, wherein the LV connectors are connected to an LV on-board electrical system of the electric motor vehicle, and the HV connectors are connected to an HV on-board electrical system of the electric motor vehicle. In principle, both the LV connectors and the HV connectors may be designed in any way known from the prior art that is suitable for carrying the respective voltages and currents, for example as connection plugs or connection terminals.

The DC/DC converter according to the invention further comprises a transformer with an LV winding and an HV winding, wherein the LV winding and the HV winding are magnetically coupled in a manner known from the prior art in such a way that when an AC input voltage is applied to one winding, an AC output voltage is induced in the other winding. The ratio between the AC input voltage and the AC output voltage can be determined in particular via the so-called transformation ratio of the transformer, i.e. the ratio of the number of turns of the LV winding and the HV winding.

The DC/DC converter according to the invention further comprises an LV semiconductor bridge circuit with LV semiconductor switches and an HV semiconductor bridge circuit with HV semiconductor switches, each comprising a plurality of, typically four, LV semiconductor switches or HV semiconductor switches, which are interconnected in a manner known from the prior art in the form of a so-called H-bridge circuit. In particular, the semiconductor bridge circuits each comprise several, typically two, so-called half-bridges, each of which includes two semiconductor switches, one of the semiconductor switches being referred to as a high-side semiconductor switch, hereinafter referred to as “HS switch” for short, and the other semiconductor switch being referred to as a low-side semiconductor switch, hereinafter referred to as “LS switch” for short. Preferably, the semiconductor switches are so-called field-effect transistors (FET), particularly preferably so-called metal-oxide-semiconductor field-effect transistors (MOSFET). Such semiconductor bridge circuits are also known as four-quadrant converters. The semiconductor switches are controlled with pulse-width modulated control signals, hereinafter referred to as “PWM signals”, in order to convert a provided DC voltage into an AC voltage or, conversely, to convert a provided AC voltage into a DC voltage.

In the DC/DC converter according to the invention, the LV semiconductor bridge circuit is connected to the LV winding of the transformer and to the LV connectors, and the HV semiconductor bridge circuit is connected to the HV winding of the transformer and to the HV connectors. The windings of the transformer are each connected to bridge points of the respective semiconductor bridge circuit located between the HV switch and the LS switch of a branch of the semiconductor bridge circuit. Preferably, a first LV connector is connected to the two LS switches of the LV semiconductor bridge circuit, and a second LV connector is connected to a first bridge point of the LV semiconductor bridge circuit via a first inductor and to a second bridge point of the LV semiconductor bridge circuit via a second inductor. Preferably, a first HV connector is connected to the two HS switches of the HV semiconductor bridge circuit, and a second HV connector is connected to the two LS switches of the HV semiconductor bridge circuit.

The DC/DC converter according to the invention further comprises a control device for controlling the LV semiconductor switches of the LV semiconductor bridge circuit and the HV semiconductor switches of the HV semiconductor bridge circuit by means of PWM signals. Such control devices are also known as gate drivers and are known from the prior art with regard to their basic function. The PWM signals typically all have the same pulse-width modulation frequency, hereinafter referred to as “PWM frequency” for short, but may have different pulse-width modulation duty cycles, also referred to as “duty cycles”, hereinafter referred to as “PWM duty cycle” for short. Preferably, all HV semiconductor switches are always controlled with a PWM duty cycle of 50%, and only the PWM duty cycles used to control the LV semiconductor switches are varied.

Typically, the LS switch and the HS switch of a half-bridge are controlled in opposite directions, i.e. in such a way that one of the two semiconductor switches is always switched on, while the other semiconductor switch is switched off. This means that the PWM duty cycles of the PWM signals of the LS switch and the HS switch of the same half-bridge typically add up to 100%—apart from dead times that are generally taken into account due to the non-ideal switching characteristics of the semiconductor switches or the circuit in practice—so that the following applies, taking into account the calculated dead times:

$$PWM duty cycle ( HS switch ) = 100 \% - PWM duty cycle ( LS switch )$$

As soon as the PWM duty cycle of one of the two semiconductor switches of a half-bridge is known, the PWM duty cycle of the other semiconductor switch of the half-bridge is therefore also known. Furthermore, all half-bridges of a semiconductor bridge circuit are typically controlled with the same PWM duty cycles for their two semiconductor switches, so that all PWM duty cycles of a semiconductor bridge circuit are typically defined by specifying a single PWM duty cycle. Unless otherwise stated, for the sake of simplicity, the PWM duty cycle referred to hereinafter shall always be understood, for the sake of simplicity, as the PWM duty cycle of the PWM signals provided to the LS switches of the LV semiconductor bridge circuit.

According to the invention, the control device is set up to detect both the LV DC voltage and the HV DC voltage by means of suitable detection means, and to determine a theoretical PWM duty cycle based on the detected LV DC voltage, the detected HV DC voltage, and the known transformation ratio of the transformer. Preferably, the control unit is set up to determine the theoretical PWM duty cycle according to the following mathematical formula:

$$theoretical PWM duty cycle = 1 - translation ratio \cdot \frac{LV DC voltage}{HV DC voltage}$$

According to the invention, the control device is further set up to distinguish whether the theoretical PWM duty cycle is greater than or equal to 50%, or less than 50%, and—if the theoretical PWM duty cycle is greater than or equal to 50%—to generate a PWM signal with a set PWM duty cycle corresponding to the theoretical PWM duty cycle and a set PWM frequency corresponding to a first PWM frequency for controlling one or more defined semiconductor switches, or—if the theoretical PWM duty cycle is less than 50%—to generate a PWM signal with a set PWM duty cycle of 50% and a set PWM frequency corresponding to a second PWM frequency, wherein the second PWM frequency is greater than the first PWM frequency, for controlling the one or more defined semiconductor switches. The control unit is therefore set up to always provide PWM signals with a set PWM duty cycle of at least 50% to the one or more defined semiconductor switches in order to ensure reliable voltage conversion by the transformer. By using the set PWM frequency corresponding to the increased second PWM frequency instead of the set PWM frequency corresponding to the first PWM frequency in cases where the theoretical PWM duty cycle is less than 50%, the conversion losses resulting from setting the set PWM duty cycle to 50% can be significantly reduced compared to using the set PWM frequency corresponding to the first PWM frequency.

Therefore, the DC/DC converter according to the invention enables efficient power transmission even when operating with relatively low HV DC voltages, without the need for further conversion stages.

In a preferred embodiment, the control device is set up to determine the second pulse-width modulation frequency based on the LV DC voltage and the HV DC voltage, whereby a particularly efficient power transmission can be achieved at relatively low HV DC voltages.

Preferably, the control device comprises a lookup table in which PWM frequency values for different voltage ratios between HV DC voltage and LV DC voltage, i.e. for different values of the quotient of HV DC voltage and LV DC voltage, are stored, wherein the control unit is set up to determine the second PWM frequency based on the lookup table, so that no complex calculations are required to determine the second PWM frequency.

Preferably, the control unit is arranged to control an LV current output from the LV connectors or an HV current output from the HV connectors by setting a phase shift between the PWM signals used to control the LV semiconductor switches of the LV semiconductor bridge circuit and the PWM signals used to control the HV semiconductor switches of the HV semiconductor bridge circuit.

In a preferred embodiment, the DC/DC converter according to the invention further comprises a clamping circuit with at least one clamping capacitor, which is connected to the LV semiconductor bridge circuit. Preferably, one connector of the clamping circuit is connected to the HS switches of the LV semiconductor bridge circuit and the other connector of the clamping circuit is connected to the LS switches of the LV semiconductor bridge circuit.

### BRIEF DESCRIPTION OF THE DRAWINGS

An exemplary embodiment of the present invention is described below with reference to the attached figures. In the figures:

FIG. 1 is a schematic diagram of a DC/DC converter according to the invention; and

FIG. 2 is a sequence executed according to the invention by a control device of the DC/DC converter of FIG. 1 for determining parameters of pulse-width modulated control signals.

### DETAILED DESCRIPTION OF THE CURRENT EMBODIMENT

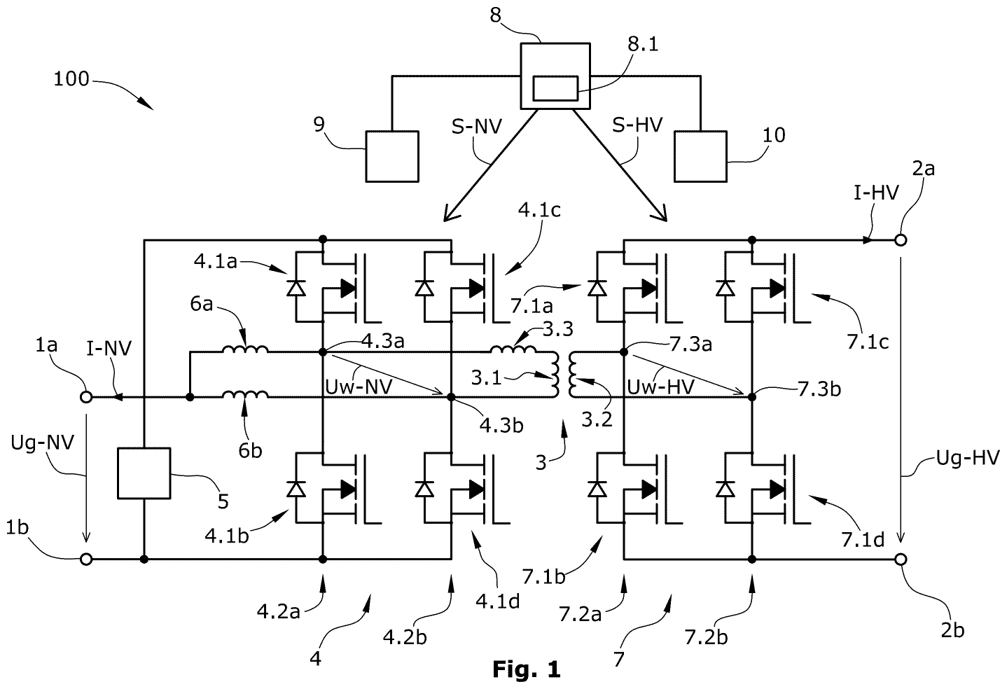

FIG. 1 shows a DC/DC converter 100 according to the invention for converting an LV DC voltage Ug-LV into a HV DC voltage Ug-HV, or vice versa.

The DC/DC converter 100 comprises LV connectors 1a, 1b, to which the LV DC voltage Ug-LV is applied during operation of the DC/DC converter 100, and HV connectors 2a, 2b, to which the HV DC voltage Ug-HV is applied during operation of the DC/DC converter 100.

The DC/DC converter 100 further comprises a transformer 3 with a LV winding 3.1, a HV winding 3.2, and a leakage inductance 3.3, wherein the LV winding 3.1 has a number of turns N-LV and the HV winding 3.2 has a number of turns N-HV and the transformer 3 thus has a transformation ratio n=N-LV/N-HV.

The DC/DC converter 100 further comprises an LV semiconductor bridge circuit 4 with four LV semiconductor switches 4.1a-4.1d, which are connected in the form of a so-called H-bridge circuit, wherein a first LV semiconductor switch 4.1a and a second LV semiconductor switch 4.1b are arranged in a first LV half-bridge 4.2a of the LV semiconductor bridge circuit 4 and a third LV semiconductor switch 4.1c and a fourth LV semiconductor switch 4.1d are arranged in a second LV half-bridge 4.2b of the LV semiconductor bridge circuit 4.

The two half-bridges 4.2a, 4.2b of the LV semiconductor bridge circuit 4 are each electrically connected to a clamping circuit 5, which comprises one or more capacitors (not shown here for reasons of clarity).

The LV semiconductor bridge circuit 4 is electrically connected to the leakage inductance 3.3 via a first LV bridge point 4.3a located in the first LV half-bridge 4.2a between the first LV semiconductor switch 4.1a and the second LV semiconductor switch 4.1b, and a second LV bridge point 4.3b located in the second LV half-bridge 4.2b between the third LV semiconductor switch 4.1c and the fourth LV semiconductor switch 4.1d, and to the LV winding 3.1 of the transformer 3.

The DC/DC converter 100 further comprises a first LV inductance 6a and a second LV inductance 6b, wherein the first LV inductance 6a is electrically connected on one side to the first LV bridge point 4.3a and on the other side to a first LV connector 1a, and wherein the second LV inductance 6b is electrically connected on one side to the second LV bridge point 4.3b and on the other side to the first LV connector 1a.

The DC/DC converter 100 further comprises an HV semiconductor bridge circuit 7 with four HV semiconductor switches 7.1a-7.1d, which are connected in the form of a so-called H-bridge circuit, wherein a first HV semiconductor switch 7.1a and a second HV semiconductor switch 7.1b are arranged in a first HV half-bridge 7.2a of the HV semiconductor bridge circuit 7 and a third HV semiconductor switch 7.1c and a fourth HV semiconductor switch 7.1d are arranged in a second HV half-bridge 7.2b of the HV semiconductor bridge circuit 7.

The two HV half-bridges 7.2a, 7.2b of the HV semiconductor bridge circuit 7 are each electrically connected to the HV connectors 2a, 2b.

The HV semiconductor bridge circuit 7 is electrically connected to the HV winding 3.2 of the transformer 3 via a first HV bridge node 7.3a located in the first HV half-bridge 7.2a between the first HV semiconductor switch 7.1a and the second HV semiconductor switch 7.1b, and a second HV bridge node 7.3b located in the second HV half-bridge 7.2b between the third HV semiconductor switch 7.1c and the fourth HV semiconductor switch 7.1d.

The DC/DC converter 100 also comprises a control device 8, which is electrically connected to the control inputs of all four LV semiconductor switches 4.1a-4.1d and to the control inputs of all four HV semiconductor switches 7.1a-7.1d (not shown here for reasons of clarity).

The control device 8 is set up to convert both an LV DC voltage Ug-LV provided via the LV connectors 1a, 1b into an HV DC voltage Ug-HV output via the HV connectors 2a, 2b and, conversely, to convert an HV DC voltage Ug-HV provided via the HV connectors 2a, 2b into an LV DC voltage Ug-LV output via the LV connectors 1a, 1b by appropriately controlling the four LV semiconductor switches 4.1a-4.1d and the four HV semiconductor switches 7.1a-7.1d.

For the first conversion mode, the control device 8 is set up to control the four LV semiconductor switches 4.1a-4.1d by means of LV PWM signals S-LV in such a way that an LV AC voltage Uw-LV is present between the LV bridge points 4.3a, 4.3b of the LV semiconductor bridge circuit 4 during operation and is thus provided to the transformer 3, which causes transformer 3 to provide an HV AC voltage Uw-HV to the HV bridge points 7.3a, 7.3b of the HV semiconductor bridge circuit 7.

For the first conversion mode, the control device 8 is also set up to control the four HV semiconductor switches 7.1a-7.1d by means of HV PWM signals S-HV in such a way that the HV DC voltage Ug-HV is provided between the HV connectors 2a, 2b during operation.

For the second conversion mode, the control device 8 is set up to control the four HV semiconductor switches 7.1a-7.1d by means of HV PWM signals S-HV in such a way that an HV AC voltage Uw-LV is present between the HV bridge points 7.3a, 7.3b of the HV semiconductor bridge circuit 7 during operation and is thus provided to the transformer 3, which causes the transformer 3 to provide an LV AC voltage Uw-LV to the LV bridge points 4.3a, 4.3b of the LV semiconductor bridge circuit 4.

For the second conversion mode, the control device 8 is also set up to control the four LV semiconductor switches 4.1a-4.1d by means of LV PWM signals S-LV in such a way that the LV DC voltage Ug-LV is provided between the LV connectors 1a, 1b during operation.

In this case, the control device 8 is set up to always generate HV-PWM signals S-HV with a set PWM duty cycle D=50%.

The control device 8 is furthermore set up to always generate the LV PWM signals S-LV in such a way that the LV semiconductor switches 4.1a, 4.1c, i.e. the HS switches of the LV semiconductor bridge circuit 4, are switched in the opposite direction to the LV semiconductor switches 4.1b, 4.1d, i.e. to the LS switches of the LV semiconductor bridge circuit 4, so that the PWM duty cycles of the LV PWM signals S-LV provided to the LV semiconductor switches 4.1a and 4.1b, as well as the PWM duty cycles of the LV PWM signals S-LV provided to the LV semiconductor switch 4.1c and 4.1d, always add up to 100%, taking into account calculated dead times.

Accordingly, the generation of LV PWM signals S-LV with a set PWM duty cycle D is therefore understood below to mean that an LV PWM signal S-LV with a PWM duty cycle D is provided to the LV semiconductor switch 4.1b and the LV semiconductor switch 4.1d in each case, and that a PWM signal with a PWM duty cycle (100%-D) is provided to the LV semiconductor switch 4.1a and the LV semiconductor switch 4.1c in each case.

In this case, the control device 8 is set up to detect the LV DC voltage Ug-LV by means of an LV monitoring device 9 and to detect the HV DC voltage Ug-HV by means of an HV monitoring device 10, and to determine a theoretical PWM duty cycle D-t based on the LV DC voltage Ug-LV, the HV DC voltage Ug-HV, and the transformation ratio n of the transformer 3 in accordance with the following mathematical formula:

$$D - t = 1 - n \cdot \frac{Ug - LV}{Ug - LV}$$

The control device 8 is also set up to generate LV PWM signals S-LV with a set PWM duty cycle D, which corresponds to the theoretical PWM duty cycle D-t, and a set PWM frequency F, which corresponds to a first PWM frequency F1, in the event that the determined theoretical PWM duty cycle D-t is greater than or equal to 50%.

The control device 8 is also set up to generate LV PWM signals S-LV with a set PWM duty cycle D=50% and a set PWM frequency F, which corresponds to a second PWM frequency F2, in the event that the theoretical PWM duty cycle D-t is less than 50%, wherein the second PWM frequency F2 is higher than the first PWM frequency F1.

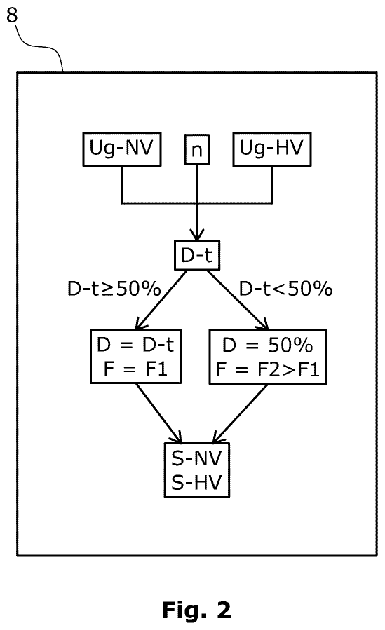

The process described above for determining the set PWM duty cycle D and the set PWM frequency F carried out by the control device 8 is shown in FIG. 2.

In this context, the control device 8 is set up to determine the second PWM frequency F2 based on the LV DC voltage Ug-LV and the HV DC voltage Ug-HV.

In particular, the control device 8 comprises a lookup table 8.1, in which PWM frequency values for different voltage ratios between LV DC voltage Ug-LV and HV DC voltage Ug-HV are stored, and the control device 8 is set up to determine the second PWM frequency F2 based on the lookup table 8.1.

The control device 8 is also configured to regulate an LV current I-LV output via the LV connectors 1a, 1b or an HV current I-HV output via the HV connectors 2a, 2b by setting a phase shift between the LV PWM signals S-LV provided to the LV semiconductor switches 4.1a-4.1d and the HV PWM signals S-HV provided to the HV semiconductor switches 7.1a-7.1d in a way known from the prior art.

### LIST OF REFERENCE SIGNS

100 DC/DC converter
1a, 1b LV connectors
2a, 2b HV connectors
3 Transformer
3.1 LV winding
3.2 HV winding
3.3 leakage inductance
4 LV semiconductor bridge circuit
4.1a-4.1d LV semiconductor switch
4.2a, 4.2b LV half-bridges
4.3a, 4.3b LV bridge points
5 clamping circuit
6a, 6b LV inductance
7 HV semiconductor bridge circuit
7.1a-7.1d HV semiconductor switch
7.2a, 7.2b HV half-bridges
7.3a, 7.3b HV bridge points
8 control device
8.1 lookup table
9 LV monitoring device
10 HV monitoring device
D set PWM duty cycle
D-t theoretical PWM duty cycle
F set PWM frequency
F1 first PWM frequency
F2 second PWM frequency
I-HV HV current
I-LV LV current
n transformation ratio
S-HV HV-PWM signals
S-LV LV-PWM signals
Ug-HV HV DC voltage
Ug-LV LV DC voltage
Uw-HV HV alternating voltage
Uw-LV LV alternating voltage

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A DC/DC converter comprising:
low-voltage connectors, to which a low-voltage DC voltage is applied during operation;
high-voltage connectors, to which a high-voltage DC voltage is applied during operation;
a transformer with a low-voltage winding and a high-voltage winding;
a low-voltage semiconductor bridge circuit with low-voltage semiconductor switches, the low-voltage semiconductor bridge circuit being connected to the low-voltage winding of the transformer and to the low-voltage connectors;
a high-voltage semiconductor bridge circuit with high-voltage semiconductor switches, the high-voltage semiconductor bridge circuit being connected to the high-voltage winding of the transformer and to the high-voltage terminals;
a control device for controlling the low-voltage semiconductor switches and the high-voltage semiconductor switches via pulse-width modulated control signals, wherein the control device is configured to:
detect the low-voltage DC voltage and the high-voltage DC voltage;
determine a theoretical pulse-width modulation duty cycle based on the low-voltage DC voltage, the high-voltage DC voltage, and a transformation ratio of the transformer; and
if the theoretical pulse-width modulation duty cycle is greater than or equal to 50%, generate a pulse-width modulated control signal with a set pulse-width modulation duty cycle corresponding to the theoretical pulse-width modulation duty cycle and with a set pulse-width modulation frequency corresponding to a first pulse-width modulation frequency; or
if the theoretical pulse-width modulation duty cycle is less than 50%, generate a pulse-width modulated control signal with a set pulse-width modulation duty cycle of 50% and with a set pulse-width modulation frequency corresponding to a second pulse-width modulation frequency, wherein the second pulse-width modulation frequency is greater than the first pulse-width modulation frequency.

2. The DC/DC converter according to claim 1, wherein the control device is configured to determine the second pulse-width modulation frequency based on the low-voltage DC voltage and the high-voltage DC voltage.

3. The DC/DC converter according to claim 1, wherein the control device comprises a lookup table in which pulse-width modulation frequency values for different voltage ratios between the low-voltage DC voltage and the high-voltage DC voltage are stored, the control device being configured to determine the second pulse-width modulation frequency based on the look-up table.

4. The DC/DC converter according to claim 1, wherein the control unit is configured to regulate a low-voltage current delivered via the low-voltage connectors or a high-voltage current delivered via the high-voltage connectors by setting a phase shift between pulse-width modulated control signals for controlling the low-voltage semiconductor switches and pulse-width modulated control signals for controlling the high-voltage semiconductor switches.

5. The DC/DC converter according to claim 1, further comprising a clamping circuit with at least one clamping capacitor connected to the low-voltage semiconductor bridge circuit.
